(19) United States
(12) Patent Application Publication
(10) Pub. No.: US 2024/0257463 A1
(43) Pub. Date: Aug. 1, 2024

(54) METHOD AND APPARATUS FOR VIRTUAL MODEL RENDERING

(71) Applicant: BEIJING ZITIAO NETWORK TECHNOLOGY CO., LTD., Beijing (CN)

(72) Inventors: Xiaofeng Li, Beijing (CN); Yi Guo, Beijing (CN)

(21) Appl. No.: 18/566,745

(22) PCT Filed: Jul. 19, 2022
(86) PCT No.: PCT/CN2022/106372

§ 371 Date: Dec. 4, 2023

(30) Foreign Application Priority Data
Jul. 30, 2021 (CN) 202110875228.5

(51) Int. Cl. G06T 17/20; G06V 10/60

(52) U.S. Cl. CPC G06T 17/20; G06V 10/60

(57) ABSTRACT

A method and an apparatus for virtual module rendering is provided by embodiments of the disclosure, which are related to the field of image rendering. The method includes selecting a plurality of target mesh vertices from mesh vertices of a target virtual model based on a predetermined manner; configuring point primitives corresponding to respective target mesh vertices; rendering the target virtual model to obtain a background image; determining attribute parameters of point primitives corresponding to respective target mesh vertices based on the background image; and rendering point primitives corresponding to respective target mesh vertices on the background image based on the attribute parameters of point primitives corresponding to the respective target mesh vertices, to generate a rendering effect image for the target virtual model.

### CROSS REFERENCE TO RELATED APPLICATIONS

The present application claims priority to Chinese Patent Application No. 202110875228.5, titled “Method and apparatus for virtual model rendering,” filed on Jul. 30, 2021, the contents of which are hereby incorporated by reference in their entirety.

### FIELD

The present disclosure relates to the field of image rendering, in particular to a method and an apparatus for virtual model rendering.

### BACKGROUND

In the process of game development, special effects production, or the like, in order to improve the rendering effect of a virtual model, it is often necessary to add Kira in a rendering image of the virtual model, so that the rendering effect image of the virtual model presents Kira effect. For example, when rendering a diamond model, adding Kira to a rendering image of the diamond model may make the rendering image of the diamond model presents Kira effect, so as to increase the beauty and authenticity of the rendering image.

### SUMMARY

In view of this, the embodiment of the present disclosure provide a method and an apparatus for virtual model rendering, and the technical scheme of the embodiments of the present disclosure is as following:

In a first aspect of the present disclosure, a method of virtual model rendering is provided. The method comprises:
selecting a plurality of target mesh vertices from mesh vertices of a target virtual model based on a predetermined manner;
configuring point primitives corresponding to respective target mesh vertices;
rendering the target virtual model to obtain a background image;
determining attribute parameters of point primitives corresponding to respective target mesh vertices based on the background image: and
rendering point primitives corresponding to respective target mesh vertices on the background image based on the attribute parameters of point primitives corresponding to the respective target mesh vertices, to generate a rendering effect image for the target virtual model.

As an alternative embodiment of the present disclosure, the selecting, based on a predetermined manner, a plurality of target mesh vertices from mesh vertices of a target virtual model comprises:
randomly selecting, based on a predefined number of point primitives, a same number of target mesh vertices from mesh vertices of the target virtual model.

As an alternative embodiment of the present disclosure, the selecting, based on a predetermined manner, a plurality of target mesh vertices from mesh vertices of a target virtual model comprises:
dividing mesh vertices of the target virtual model into a plurality of mesh vertex sets based on a sparse degree of the predefined point primitives: and
randomly selecting a target mesh vertex from each mesh vertex set in the plurality of mesh vertex sets respectively.

As an alternative embodiment of the present disclosure, the determining, based on the background image, attribute parameters of point primitives corresponding to respective target mesh vertices comprises at least one of:
determining, based on the background image, visibility parameters of point primitives corresponding to respective target mesh vertices, the visibility parameters comprising a first parameter for characterizing visibility of corresponding point primitives or a second parameter for characterizing invisibility of corresponding point primitives;
determining, based on the background image, rendering positions of point primitives corresponding to respective target mesh vertices;
determining, based on the background image, brightness of point primitives corresponding to respective target mesh vertices: or
determining, based on the background image, sizes of point primitives corresponding to respective target mesh vertices.

As an alternative embodiment of the present disclosure, the determining, based on the background image, visibility parameters of point primitives corresponding to respective target mesh vertices comprises:
obtaining brightness of pixels corresponding to respective target mesh vertices in the background image;
deciding whether brightness of pixels corresponding to respective target mesh vertices is greater than or equal to a threshold brightness; and
determining, based on a result of the decision, visibility parameters of point primitives corresponding to the target mesh vertices.

As an alternative embodiment of the present disclosure, the determining, based on decided results, visibility parameters of point primitives corresponding to the target mesh vertices comprises:
if brightness of pixels corresponding to the target mesh vertices is greater than or equal to the threshold brightness, determining visibility parameters of point primitives corresponding to the target mesh vertices as the first parameter: and
if brightness of pixels corresponding to the target mesh vertices is less than the threshold brightness, determining visibility parameters of point primitives corresponding to the target mesh vertices as the second parameter.

As an alternative embodiment of the present disclosure, the determining, based on the background image, rendering positions of point primitives corresponding to respective target mesh vertices comprises:
obtaining position coordinates of respective target mesh vertices in the background image: and
determining position coordinates of respective target mesh vertices as rendering positions of point primitives corresponding to respective target mesh vertices.

As an alternative embodiment of the present disclosure, the determining, based on the background image, brightness of point primitives corresponding to respective target mesh vertices comprises:
obtaining brightness of pixels corresponding to respective target mesh vertices in the background image: and
determining brightness of point primitives corresponding to respective target mesh vertices based on brightness of pixels corresponding to the respective target mesh vertices,
wherein brightness of point primitives corresponding to the target mesh vertices is positively correlated with brightness of pixels corresponding to the target mesh vertices.

As an alternative embodiment of the present disclosure, the determining, based on the background image, sizes of point primitives corresponding to respective target mesh vertices comprises:
obtaining depths of pixels corresponding to respective target mesh vertices in the background image: and
determining sizes of point primitives corresponding to respective target mesh vertices based on depths of pixels corresponding to respective target mesh vertices,
wherein sizes of point primitives corresponding to the target mesh vertices are negatively correlated with depths of pixels corresponding to the target mesh vertices.

As an alternative embodiment of the present disclosure, the method further comprises:
obtaining a moment corresponding to the rendering effect image: and
adjusting, based on the moment, brightness and/or sizes of point primitives corresponding to respective target mesh vertices.

In a second aspect of the present disclosure, an apparatus for virtual model rendering is provided. The apparatus comprises:
a selecting module configured to select a plurality of target mesh vertices from mesh vertices of a target virtual model based on a predetermined manner;
a configuring module configured to set point primitives on respective target mesh vertices respectively;
a rendering module configured to render the target virtual model to obtain a background image;
a determining module configured to determine attribute parameters of point primitives corresponding to respective target mesh vertices based on the background image; and
the rendering module further configured to render point primitives corresponding to respective target mesh vertices on the background image based on the attribute parameters of point primitives corresponding to the respective target mesh vertices, to generate a rendering effect image for the target virtual model.

As an alternative embodiment of the present disclosure, the selecting module is configured to randomly select, based on a predefined number of point primitives, a same number of target mesh vertices from mesh vertices of the target virtual model.

As an alternative embodiment of the present disclosure, the selecting module is configured to divide mesh vertices of the target virtual model into a plurality of mesh vertex sets based on a sparse degree of the predefined point primitives: and randomly select a target mesh vertex from each mesh vertex set in the plurality of mesh vertex sets respectively.

As an alternative embodiment of the present disclosure, the determining module is configured to at least one of:
determine, based on the background image, visibility parameters of point primitives corresponding to respective target mesh vertices, and the visibility parameters comprise a first parameter for characterizing visibility of corresponding point primitives or a second parameter for characterizing invisibility of corresponding point primitives;
determine, based on the background image, rendering positions of point primitives corresponding to respective target mesh vertices;
determine, based on the background image, brightness of point primitives corresponding to respective target mesh vertices: or
determine, based on the background image, sizes of point primitives corresponding to respective target mesh vertices.

As an alternative embodiment of the present disclosure, the determining module is configured to obtain brightness of pixels corresponding to respective target mesh vertices in the background image: decide whether brightness of pixels corresponding to respective target mesh vertices is greater than or equal to a threshold brightness: and determine, based on a result of the decision, visibility parameters of point primitives corresponding to the target mesh vertices.

As an alternative embodiment of the present disclosure, the determining module is configured to, if brightness of pixels corresponding to the target mesh vertices is greater than or equal to the threshold brightness, determine visibility parameters of point primitives corresponding to the target mesh vertices as the first parameter: and if brightness of pixels corresponding to the target mesh vertices is less than the threshold brightness, determine visibility parameters of point primitives corresponding to the target mesh vertices as the second parameter.

As an alternative embodiment of the present disclosure, the determining module is configured to obtain position coordinates of respective target mesh vertices in the background image: and determine position coordinates of respective target mesh vertices as rendering positions of point primitives corresponding to respective target mesh vertices.

As an alternative embodiment of the present disclosure, the determining module is configured to obtain brightness of pixels corresponding to respective target mesh vertices in the background image: and determine brightness of point primitives corresponding to respective target mesh vertices based on brightness of pixels corresponding to the respective target mesh vertices,
wherein brightness of point primitives corresponding to the target mesh vertices is positively correlated with brightness of pixels corresponding to the target mesh vertices.

As an alternative embodiment of the present disclosure, the determining module is configured to obtain depths of pixels corresponding to respective target mesh vertices in the background image: and determine sizes of point primitives corresponding to respective target mesh vertices based on depths of pixels corresponding to respective target mesh vertices,
wherein sizes of point primitives corresponding to the target mesh vertices are negatively correlated with depths of pixels corresponding to the target mesh vertices.

As an alternative embodiment of the present disclosure, the determining module is configured to obtain a moment corresponding to the rendering effect image: and adjust, based on the moment, brightness and/or sizes of point primitives corresponding to respective target mesh vertices.

In a third aspect of the present disclosure, an electronic device is provided. The electronic device comprises a memory and a processor, wherein the memory is configured to store a computer program: the processor is configured to cause the electronic device to implement the method of virtual model rendering of any of the embodiments mentioned above when executing the computer program.

In a fourth aspect of the present disclosure, a computer readable storage medium is provided. A computer program is stored in the computer readable storage medium, and the computer program, when executed by a computing device, causes the computing device to implement the method of virtual model rendering of any of the embodiments mentioned above.

In a fifth aspect of the present disclosure, a computer program product is provided. The computer program product, when executed on a computer, causes the computer to implement the method of virtual model rendering of any of the embodiments mentioned above.

### BRIEF DESCRIPTION OF THE DRAWINGS

The accompanying drawings herein, which are incorporated in and constitute a part of this description, illustrate embodiments consistent with the present disclosure and, together with the description, explain the principles of the present disclosure.

In order to more clearly illustrate the embodiments of the present disclosure or technical solutions in the prior art, the drawings that need to be called in the description of the embodiments or the prior art will be briefly described below, and it is obvious that, for one of ordinary skill in the art, other drawings can also be obtained from these drawings without paying creative efforts.

FIG. 1 is a flow diagram of steps of a method of virtual model rendering provided by the embodiments of the present disclosure:

FIG. 2 is a schematic structural diagram of an apparatus for virtual model rendering provided by the embodiments of the present disclosure:

FIG. 3 is a schematic hardware structural diagram of an electronic device provided by the embodiments of the present disclosure.

### DETAILED DESCRIPTION

In order to enable more clear understanding of the above objectives, features and advantages of the present disclosure, solutions of the present disclosure will be further described below. It should be noted that the embodiments of the present disclosure and features in the embodiments can be combined with each other provided there is no conflict.

In the following description, numerous specific details are set forth to facilitate full understanding of the present disclosure, but the present disclosure can also be implemented in other manners different from those described herein: and it is obvious that the embodiments in this specification are only part of the embodiments of the present disclosure, and not all of them.

In the embodiments of the present disclosure, words such as “exemplary” or “for example” are used for indicating giving an example, illustration or description. Any embodiment or design solution described as “exemplary” or “for example” in the embodiments of the present disclosure shall not be interpreted as more preferred or advantageous over other embodiments or design solutions. Rather, calling the word such as “exemplary” or “for example” is intended to present a related concept in a specific manner. Furthermore, in the description of the embodiments of the present disclosure, “a plurality” means two or more unless otherwise specified.

The Kira effect of a rendering effect image is generally achieved by a full-screen post-processing manner in the prior art. Specifically, a rendering effect image containing a virtual model but with no Kira effect is firstly generated. When the rendering effect image is output, a Kira image is overlayed and presented on the top of the rendering effect image, thereby obtaining the rendering effect image with Kira effect. Because for the Kira effect of the rendering effect image achieved by the full-screen post-processing manner, the Kira image needs to be overlayed on the rendering effect image while the rendering effect image is displayed, the performance overhead of this manner to achieve the Kira effect of the rendering effect image is relatively high.

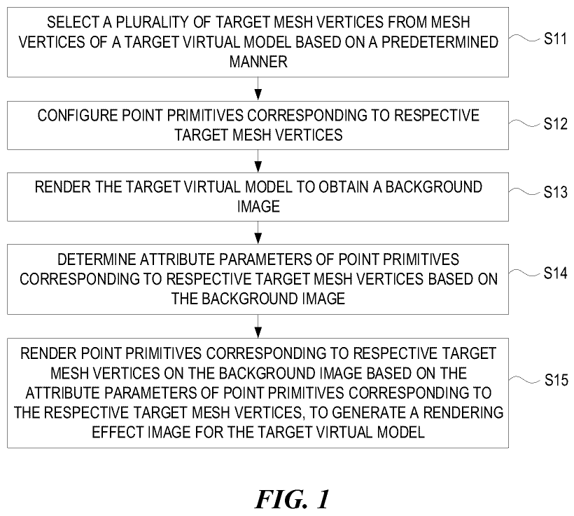

Based on the above problems in the prior art, the embodiments of the present disclosure provide a method of virtual model rendering. As shown in FIG. 1, the method of virtual model rendering includes the following steps.

S11. Select a plurality of target mesh vertices from mesh vertices of a target virtual model based on a predetermined manner.

Specifically, the target virtual model in the embodiments of the present disclosure is a mesh model that adopts a plurality of interconnected polygons (meshes) to represent an object in a real world or a virtual world, and the mesh vertices of the target virtual model refer to vertices of respective polygons in the mesh model. The object represented by the target virtual model may include but is not limited to at least one of: a diamond, virtual clothing, an ice cube, glass. The polygon may include but is not limited to at least one of: a triangle, a parallelogram, a rectangle. The embodiments of the present disclosure do not limit the object represented by the virtual model and the mesh shape of the target virtual model.

Further, the above step S11 (select a plurality of target mesh vertices from mesh vertices of a target virtual model based on a predetermined manner) may be implemented at least in the two following ways.

### Implementation 1

Randomly select, based on a predefined number of point primitives, a same number of target mesh vertices from mesh vertices of the target virtual model.

That is, randomly select, based on a predefined number of point primitives, target mesh vertices from mesh vertices of the target virtual model.

For example, if the predefined number of point primitives is 100 and the number of mesh vertices of the target virtual model is 10000, then the selecting, based on the predetermined manner, the plurality of target mesh vertices from mesh vertices of the target virtual model may be implemented as: randomly selecting 100 mesh vertices from 10000 mesh vertices of the target virtual model.

### Implementation 2

Divide mesh vertices of the target virtual model into a plurality of mesh vertex sets based on a sparse degree of the predefined point primitives; and randomly select a target mesh vertex from each mesh vertex set in the plurality of mesh vertex sets respectively.

That is, randomly select the target mesh vertex from the mesh vertices of the target virtual model based on the predetermined sparsity degree.

For example, if the predetermined sparsity degree is that one target mesh vertex is selected from every 100 mesh vertices, and the total number of mesh vertices in the target virtual model is 15000, then randomly selecting, based on a predefined number of point primitives, a same number of target mesh vertices from mesh vertices of the target virtual model may be implemented as: evenly dividing the 15000 mesh vertices in the target virtual model into 150 mesh vertex sets, then randomly selecting a mesh vertex from each mesh vertex set as the target mesh vertex, and 150 target mesh vertices being selected.

S12. Configure point primitives corresponding to respective target mesh vertices.

Alternatively, there is a one-to-one correspondence between the target mesh vertices and point primitives in the embodiments of the present disclosure. That is, each target mesh vertex is configured with and uniquely configured with a corresponding point primitive.

For example, the point primitives corresponding to respective target mesh vertices may be set on respective target mesh vertices, thereby realizing the configuration of the point primitives corresponding to respective target mesh vertices.

S13. Render the target virtual model to obtain a background image.

Because the background image is an image obtained by rendering the target virtual model, the background image includes the object represented by the target virtual model. The embodiments of the present disclosure do not limit the rendering manner used for rendering the target virtual model. The target virtual model may be rendered in any rendering manner, to obtain the background image including the object represented by the target virtual model.

S14. Determine attribute parameters of point primitives corresponding to respective target mesh vertices based on the background image.

As an alternative embodiment of the present disclosure, the above step S14 (determine attribute parameters of point primitives corresponding to respective target mesh vertices based on the background image) may include at least one of the following 1 to 4:
1. Determine, based on the background image, visibility parameters of point primitives corresponding to respective target mesh vertices.

The visibility parameters comprise a first parameter for characterizing visibility of corresponding point primitives or a second parameter for characterizing invisibility of corresponding point primitives.
2. Determine, based on the background image, rendering positions of point primitives corresponding to respective target mesh vertices.
3. Determine, based on the background image, brightness of point primitives corresponding to respective target mesh vertices.
4. Determine, based on the background image, sizes of point primitives corresponding to respective target mesh vertices.

That is, the attribute parameters of the point primitive include at least one of: the visibility parameter, the rendering position, the brightness, or the size.

It should be noted that the attribute parameters of the point primitives in the embodiments of the present disclosure may further include, in addition to the visibility parameter, the rendering position, the brightness, or the size, at least one of rendering texture, a brightness changing rate when flashing, a brightness changing range when flashing, a size changing rate when flashing, or a size changing range when flashing. The rendering texture, the brightness changing rate when flashing, the brightness changing range when flashing, the size changing rate when flashing, the size changing range when flashing may be set to any value by users based on their requirements, so that the image rendering effect obtained based on the method of virtual model rendering of the embodiments of the present disclosure may be more diversified, and the user experience is improved.

S15. Render point primitives corresponding to respective target mesh vertices on the background image based on the attribute parameters of point primitives corresponding to the respective target mesh vertices, to generate a rendering effect image for the target virtual model.

Specifically, if the attribute parameters of the point primitives may include: the visibility parameter, the rendering position, the brightness or the size, implementations of the above step S15 (render point primitives corresponding to respective target mesh vertices on the background image based on the attribute parameters of point primitives corresponding to the respective target mesh vertices, to generate a rendering effect image for the target virtual model) may include steps a and b as following.

Step a. Obtain a set of point primitives to be rendered based on the visibility parameters of the point primitives corresponding to respective target mesh vertices.

The set of point primitives to be rendered is the set composed of point primitives whose visibility parameter is the first parameter in the point primitives corresponding to respective target mesh vertices.

Specifically, because the point primitive whose visibility parameter is the second parameter is not visible, there is no need to render this part of the point primitive in the actual rendering process. Therefore, the point primitive whose visibility parameter is the second parameter may be deleted from the point primitives to be rendered, to avoid obtaining other parameters of this part of the point primitive based on the background image, thereby reducing the number of point primitives to be processed and reducing the amount of data that needs to be processed when rendering the target virtual model.

Step b. Render respective point primitives in the set of point primitives to be rendered at the rendering position of respective point primitives based on the brightness and the size of respective point primitives in the set of point primitives to be rendered, to generate the rendering effect image of the target virtual model.

When rendering the virtual model according to the method of virtual model rendering in the embodiment of the present disclosure, a plurality of target mesh vertices are firstly selected from mesh vertices of a target virtual model based on a predetermined manner, and point primitives corresponding to respective target mesh vertices are configured. Then, the target virtual model is rendered to obtain a background image. Attribute parameters of point primitives corresponding to respective target mesh vertices are determined based on the background image. Point primitives corresponding to respective target mesh vertices are rendered on the background image based on the attribute parameters of point primitives corresponding to the respective target mesh vertices, to generate a rendering effect image for the target virtual model. Because the rendering effect image of the target virtual model in the embodiments of the present disclosure is the image obtained by rendering the point primitives corresponding to respective target mesh vertices on the background image that is obtained by rendering the target virtual model, the rendering effect image generated in the embodiments of the present disclosure is a rendering effect image with Kira effect. Compared with the realization of the rendering effect image with 30) Kira effect through full-screen post-processing manner, the Kira image does not need to be overlayed on the rendering effect image while the rendering effect image is displayed in the embodiments of the present disclosure. Therefore, the embodiments of the present disclosure may reduce the performance overhead in realizing the rendering effect image with Kira effect. It solves the problem that the performance overhead of achieving the rendering effect image with Kira effect through the full-screen post-processing manner is relatively large.

In addition, because the plurality of target mesh vertices are selected from mesh vertices of the target virtual model based on the predetermined manner, and point primitives corresponding to respective target mesh vertices are configured in the embodiments of the present disclosure, the number and the density of the target mesh vertices may be selected according to requirements, and the number and the density of Kira may be set to any value.

Further, because the attribute parameters of the point primitive in the embodiments of the present disclosure may include the brightness and the size of the point primitives, the brightness and the size of the point primitives of the embodiments of the present disclosure may be set to any value according to the demand, to achieve Kira flashing effect changing over time. Moreover, a scaling degree, a shading degree and a flashing rate of the point primitive during the flashing process may be further controlled by the maximum value, the minimum value of the point primitive, and a changing rate between the maximum and the minimum values.

Further, if the method of virtual model rendering provided by the embodiments of the present disclosure is compiled as a script, then any virtual model may realize the Kira effect after adding the script obtained by compiling the method of virtual model rendering provided by the embodiments of the present disclosure. The Kira effect can be realized conveniently and quickly, and the performance overhead is very small.

It should be further noted that if the rendering effect image with Kira effect is realized by the full-screen post-processing manner, there is a problem that Kira does not appear on the object corresponding to the virtual model but appears in other areas besides the object corresponding to the virtual model. The point primitive in the embodiments mentioned above corresponds to the mesh vertex of the point primitive, therefore it can be ensured that the point primitive is rendered on the object corresponding to the target virtual model, and it can be avoided that the point primitive is rendered in areas other than the object corresponding to the target virtual model.

As an alternative embodiment of the present disclosure, the determining, based on the background image, visibility parameters of point primitives corresponding to respective target mesh vertices comprises steps 1 to 3 as following.

Step 1. Obtain brightness of pixels corresponding to respective target mesh vertices in the background image.

Step 2. Decide whether brightness of pixels corresponding to respective target mesh vertices is greater than or equal to a threshold brightness.

Step 3. Determine, based on a result of the decision, visibility parameters of point primitives corresponding to the target mesh vertices.

Optionally, the above step 3 (determine, based on a result of the decision, visibility parameters of point primitives corresponding to the target mesh vertices) includes:
if brightness of pixels corresponding to the target mesh vertices is greater than or equal to the threshold brightness, determining visibility parameters of point primitives corresponding to the target mesh vertices as the first parameter;
if brightness of pixels corresponding to the target mesh vertices is less than the threshold brightness, determining visibility parameters of point primitives corresponding to the target mesh vertices as the second parameter.

That is, in the above step 2, if the brightness of the pixel corresponding to any target mesh vertex is greater than or equal to the threshold brightness, the visibility parameter of the point primitive corresponding to the target mesh vertex is determined as the first parameter. If the brightness of the pixel corresponding to any target mesh vertex is less than the threshold brightness, the visibility parameter of the point primitive corresponding to the target mesh vertex is determined as the second parameter, to determine the visibility parameter of the point primitive corresponding to the target mesh vertex according to the brightness of the pixel corresponding to the target mesh vertex, and whether to render the point primitive is decided based on the visibility parameter of the point primitive when rendering the point primitive.

In practice, the area with low brightness of the object represented by the network model is generally the backlight side, and there will be no reflection spot. If the point primitive is rendered in the position with low brightness, the rendering effect image will be less realistic. In the embodiments mentioned above, the brightness of the pixel corresponding to the target mesh vertex is firstly obtained, and then whether to render the point primitive corresponding to the target mesh vertex is determined based on the brightness of the pixel corresponding to the target mesh vertex. Therefore, the embodiments mentioned above may avoid rendering the point primitive in the area with low brightness, thereby making the rendering effect image more realistic.

As an alternative embodiment of the present disclosure, the determining, based on the background image, rendering positions of point primitives corresponding to respective target mesh vertices comprises the following step I and step II.

Step I. Obtain position coordinates of respective target mesh vertices in the background image.

Specifically, the position coordinates of the target mesh vertices in the background image may be pixel coordinates of the pixels corresponding to the target mesh vertices.

For example, if a pixel corresponding to a target mesh vertex is a pixel of the 102^{nd} row and the 451^{st} column in the background image, then the position coordinate of the target mesh vertex may be expressed as (102, 451).

Step II. Determine position coordinates of respective target mesh vertices as rendering positions of point primitives corresponding to respective target mesh vertices.

It should be noted that in the actual rendering, the rendering area of a point primitive may include multiple pixels, which is determined by the size of the point primitive. If the rendering area of the point primitive includes multiple pixels, the rendering position of the point primitive may be the geometric center of the rendering area of the point primitive.

As an alternative embodiment of the present disclosure, the determining, based on the background image, brightness of point primitives corresponding to respective target mesh vertices comprises the following step (1) and step (2).

Step (1). Obtain brightness of pixels corresponding to respective target mesh vertices in the background image.

Step (2). Determine brightness of point primitives corresponding to respective target mesh vertices based on brightness of pixels corresponding to the respective target mesh vertices.

The brightness of a point primitive corresponding to any target mesh vertex is positively correlated with the brightness of pixel corresponding to the target mesh vertex.

That is, the greater the brightness of the pixel corresponding to the target mesh vertex, the greater the brightness of the point primitive corresponding to the target mesh vertex. Conversely, the lower the brightness of the pixel corresponding to the target mesh vertex, the lower the brightness of the point primitive corresponding to the target mesh vertex.

In the embodiments mentioned above, the brightness of point primitives corresponding to respective target mesh vertices is determined based on the brightness of pixels corresponding to the respective target mesh vertices, and the brightness of point primitives corresponding to the target mesh vertices is positively correlated with the brightness of pixels corresponding to the target mesh vertices. Therefore, the brightness of the point primitive may match the brightness of the object represented by the target network model through the embodiments mentioned above.

As an alternative embodiment of the present disclosure, the determining, based on the background image, sizes of point primitives corresponding to respective target mesh vertices comprises the following step \textcircled{1} and step \textcircled{2}.

Step \textcircled{1}. Obtain depths of pixels corresponding to respective target mesh vertices in the background image.

Specifically, the depth of the pixel corresponding to the target mesh vertex in the embodiments of the present disclosure may be a value for representing the distance between the target mesh vertex and the virtual camera.

Step \textcircled{2}. Determine sizes of point primitives corresponding to respective target mesh vertices based on depths of pixels corresponding to respective target mesh vertices.

Sizes of point primitives corresponding to the target mesh vertices are negatively correlated with depths of pixels corresponding to the target mesh vertices.

That is, the larger the depths of the pixels corresponding to the target mesh vertices, the smaller the sizes of the point primitives corresponding to the target mesh vertices. Conversely, the smaller the depths of the pixels corresponding to the target mesh vertices, the larger the sizes of the point primitives corresponding to the target mesh vertices.

In the above embodiments, sizes of point primitives corresponding to respective target mesh vertices are determined based on depths of pixels corresponding to respective target mesh vertices, and sizes of point primitives corresponding to the target mesh vertices are negatively correlated with depths of pixels corresponding to the target mesh vertices. Therefore, the above embodiments can realize the effect that the point primitives appear smaller when far away and larger when closer, thereby making the final generated rendering effect image more realistic.

Further, on the basis of the above embodiments, the method of virtual model rendering provided by the embodiments of the present disclosure further include:
obtaining a moment corresponding to the rendering effect image: and adjusting, based on the moment, brightness and/or sizes of point primitives corresponding to respective target mesh vertices.

The moment corresponding to the rendering effect image in the embodiments of the present disclosure may include a moment under any time reference frame. For example, the system moment of the rendering system, the authorization moment of the authorization system, the relative moment of the rendering effect image relative to other rendering effect images, or the like. Further, the moment corresponding to the rendering effect image may be the moment when the rendering effect image starts to be rendered, the output moment of the rendering effect image, or the like.

Because the moment corresponding to the rendering effect image is obtained, and brightness and/or sizes of point primitives corresponding to respective target mesh vertices are adjusted based on the moment in the above embodiments, the above embodiment can make point primitives in an multi-frame continuous rendering effect image of the target network model present the effect of brightness and/or size changing over time, thereby causing the flashing effect to be presented by the rendering effect image.

Based on the same invention concept, as the realization of the above method, the embodiments of the present disclosure further provide an apparatus for virtual model rendering, and apparatus embodiments correspond to the above method embodiments. For ease of reading, the apparatus embodiments will not repeat the details of the above method embodiments one by one. However, it should be clear that the apparatus for virtual model rendering in the embodiments of the present disclosure may correspond to the realization of all the contents of the above-mentioned method embodiments.

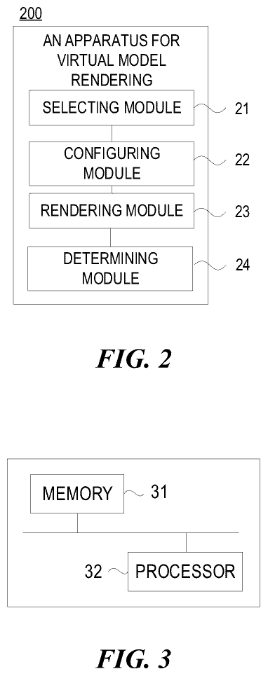

An apparatus for virtual model rendering is provided in the embodiments of the present disclosure. FIG. 2 is a structural diagram of the apparatus for virtual model rendering. As shown in FIG. 2, the apparatus for virtual model rendering 200 includes:
a selecting module 21 configured to select a plurality of target mesh vertices from mesh vertices of a target virtual model based on a predetermined manner;
a configuring module 22 configured to set point primitives on respective target mesh vertices respectively;
a rendering module 23 configured to render the target virtual model to obtain a background image;
a determining module 24 configured to determine attribute parameters of point primitives corresponding to respective target mesh vertices based on the background image; and
the rendering module 23 further configured to render point primitives corresponding to respective target mesh vertices on the background image based on the attribute parameters of point primitives corresponding to the respective target mesh vertices, to generate a rendering effect image for the target virtual model.

It should be noted that, in the above embodiment, a functional module configured to render the target virtual model to obtain a background image and a functional module configured to render point primitives corresponding to respective target mesh vertices on the background image based on the attribute parameters of point primitives corresponding to the respective target mesh vertices, to generate a rendering effect image for the target virtual model are taken as the same functional module as an example to explain. However, these two functional modules may further be different functional modules in practice.

As an alternative embodiment of the present disclosure, the selecting module 21 is specifically configured to randomly select, based on a predefined number of point primitives, a same number of target mesh vertices from mesh vertices of the target virtual model.

As an alternative embodiment of the present disclosure, the selecting module 21 is specifically configured to divide mesh vertices of the target virtual model into a plurality of mesh vertex sets based on a sparse degree of the predefined point primitives: and randomly select a target mesh vertex from each mesh vertex set in the plurality of mesh vertex sets respectively.

As an alternative embodiment of the present disclosure, the determining module 24 is specifically configured to at least one of the following:
determine, based on the background image, visibility parameters of point primitives corresponding to respective target mesh vertices, and the visibility parameters comprise a first parameter for characterizing visibility of corresponding point primitives or a second parameter for characterizing invisibility of corresponding point primitives;
determine, based on the background image, rendering positions of point primitives corresponding to respective target mesh vertices;
determine, based on the background image, brightness of point primitives corresponding to respective target mesh vertices: or
determine, based on the background image, sizes of point primitives corresponding to respective target mesh vertices.

As an alternative embodiment of the present disclosure, the determining module 24 is specifically configured to obtain brightness of pixels corresponding to respective target mesh vertices in the background image: decide whether brightness of pixels corresponding to respective target mesh vertices is greater than or equal to a threshold brightness: and determine, based on a result of the decision, visibility parameters of point primitives corresponding to the target mesh vertices.

As an alternative embodiment of the present disclosure, the determining module 24 is specifically configured to, if brightness of pixels corresponding to the target mesh vertices is greater than or equal to the threshold brightness, determine visibility parameters of point primitives corresponding to the target mesh vertices as the first parameter: and if brightness of pixels corresponding to the target mesh vertices is less than the threshold brightness, determine visibility parameters of point primitives corresponding to the target mesh vertices as the second parameter.

As an alternative embodiment of the present disclosure, the determining module 24 is specifically configured to obtain position coordinates of respective target mesh vertices in the background image: and determine position coordinates of respective target mesh vertices as rendering positions of point primitives corresponding to respective target mesh vertices.

As an alternative embodiment of the present disclosure, the determining module 24 is specifically configured to obtain brightness of pixels corresponding to respective target mesh vertices in the background image: and determine brightness of point primitives corresponding to respective target mesh vertices based on brightness of pixels corresponding to the respective target mesh vertices, wherein brightness of point primitives corresponding to the target mesh vertices is positively correlated with brightness of pixels corresponding to the target mesh vertices.

As an alternative embodiment of the present disclosure, the determining module 24 is specifically configured to obtain depths of pixels corresponding to respective target mesh vertices in the background image: and determine sizes of point primitives corresponding to respective target mesh vertices based on depths of pixels corresponding to respective target mesh vertices, wherein sizes of point primitives corresponding to the target mesh vertices are negatively correlated with depths of pixels corresponding to the target mesh vertices.

As an alternative embodiment of the present disclosure, the determining module 24 is further configured to obtain a moment corresponding to the rendering effect image; and adjust, based on the moment, brightness and/or sizes of point primitives corresponding to respective target mesh vertices.

Based on the same invention concept, an embodiment of the present disclosure further provides an electronic device. FIG. 3 is a schematic structural diagram of an electronic device provided by the embodiments of the present disclosure, as shown in FIG. 3, the electronic device provided by the embodiment comprising: a memory 31 and a processor 32, the memory 31 being configured to store a computer program: and the processor 32 being configured to perform, when executing the computer program, the method of virtual model rendering provided by the above embodiments.

An embodiment of the present disclosure further provides a non-transitory computer-readable storage medium having thereon stored a computer program which, when executed by a computing device, causes the computing device to implement the method of virtual model rendering provided by the above embodiments.

An embodiment of the present disclosure further provides a computer program product which, when running on a computer, causes the computer to implement the method of virtual model rendering provided by the above embodiments.

It should be appreciated by one skilled in the art that, the embodiments of the present disclosure can be provided as a method, system, or computer program product. Accordingly, the present disclosure can take a form of an entire hardware embodiment, an entire software embodiment or an embodiment combining software and hardware aspects. Moreover, the present disclosure can take a form of a computer program product implemented on one or more computer-usable storage media having computer-usable program code embodied therein.

The processor can be a central processing unit (CPU), and can also be another general-purpose processor, a digital signal processor (DSP), an application specific integrated circuit (ASIC), a field-programmable gate array (FPGA) or other programmable logic devices, a discrete gate or transistor logic, a discrete hardware component, etc. The general-purpose processor can be a microprocessor and can also be any conventional processor, or the like.

The memory can include a non-permanent memory, random access memory (RAM), and/or non-volatile memory in a computer-readable medium, such as a read-only memory (ROM) or flash memory (flash RAM). The memory is an example of the computer-readable medium.

The computer-readable medium includes permanent and non-permanent, removable and non-removable storage media. The storage medium can implement information storage by any method or technology, and information can be a computer-readable instruction, data structure, a module of a program, or other data. Examples of the storage medium of a computer include, but are not limited to, a phase-change random access memory (PRAM), static random access memory (SRAM), dynamic random access memory (DRAM), other types of random access memory (RAM), read-only memory (ROM), electrically erasable programmable read-only memory (EEPROM), flash memory or other memory technology, compact disc read-only memory (CD-ROM), digital versatile disks (DVD) or other optical storage, magnetic cassette, magnetic disk storage or other magnetic storage device, or any other non-transmission medium, which can be used for storing information that can be accessed by the computing device. As defined herein, the computer-readable medium does not include computer readable transitory media such as modulated data signals and carrier waves.

Finally, it should be noted that: the above embodiments are only used for illustrating the technical solutions of the present disclosure, and not limiting them; while the present disclosure has been described in detail with reference to the foregoing embodiments, it should be understood by one of ordinary skill in the art that: the technical solutions described in the foregoing embodiments can be modified, or some or all of the technical features can be equivalently replaced: and these modifications or replacements do not make the spirit of corresponding technical solutions depart from the scope of the technical solutions of the embodiments of the present disclosure.

1. A method of virtual model rendering, comprising:
selecting a plurality of target mesh vertices from mesh vertices of a target virtual model based on a predetermined manner;
configuring point primitives corresponding to respective target mesh vertices;
rendering the target virtual model to obtain a background image;
determining attribute parameters of point primitives corresponding to respective target mesh vertices based on the background image; and
rendering point primitives corresponding to respective target mesh vertices on the background image based on the attribute parameters of point primitives corresponding to the respective target mesh vertices, to generate a rendering effect image for the target virtual model.

2. The method of claim 1, wherein the selecting, based on a predetermined manner, a plurality of target mesh vertices from mesh vertices of a target virtual model comprises:
randomly selecting, based on a predefined number of point primitives, a same number of target mesh vertices from mesh vertices of the target virtual model.

3. The method of claim 1, wherein the selecting, based on a predetermined manner, a plurality of target mesh vertices from mesh vertices of a target virtual model comprises:
dividing mesh vertices of the target virtual model into a plurality of mesh vertex sets based on a sparse degree of the predefined point primitives; and
randomly selecting a target mesh vertex from each mesh vertex set in the plurality of mesh vertex sets respectively.

4. The method of claim 1, wherein the determining, based on the background image, attribute parameters of point primitives corresponding to respective target mesh vertices comprises at least one of:
determining, based on the background image, visibility parameters of point primitives corresponding to respective target mesh vertices, the visibility parameters comprising a first parameter for characterizing visibility of corresponding point primitives or a second parameter for characterizing invisibility of corresponding point primitives;
determining, based on the background image, rendering positions of point primitives corresponding to respective target mesh vertices;
determining, based on the background image, brightness of point primitives corresponding to respective target mesh vertices; or
determining, based on the background image, sizes of point primitives corresponding to respective target mesh vertices.

5. The method of claim 4, wherein the determining, based on the background image, visibility parameters of point primitives corresponding to respective target mesh vertices comprises:
obtaining brightness of pixels corresponding to respective target mesh vertices in the background image;
deciding whether brightness of pixels corresponding to respective target mesh vertices is greater than or equal to a threshold brightness; and
determining, based on a result of the decision, visibility parameters of point primitives corresponding to the target mesh vertices.

6. The method of claim 5, wherein the determining, based on decided results, visibility parameters of point primitives corresponding to the target mesh vertices comprises:
if brightness of pixels corresponding to the target mesh vertices is greater than or equal to the threshold brightness, determining visibility parameters of point primitives corresponding to the target mesh vertices as the first parameter; and
if brightness of pixels corresponding to the target mesh vertices is less than the threshold brightness, determining visibility parameters of point primitives corresponding to the target mesh vertices as the second parameter.

7. The method of claim 4, wherein the determining, based on the background image, rendering positions of point primitives corresponding to respective target mesh vertices comprises:
obtaining position coordinates of respective target mesh vertices in the background image; and
determining position coordinates of respective target mesh vertices as rendering positions of point primitives corresponding to respective target mesh vertices.

8. The method of claim 4, wherein the determining, based on the background image, brightness of point primitives corresponding to respective target mesh vertices comprises:
obtaining brightness of pixels corresponding to respective target mesh vertices in the background image; and
determining brightness of point primitives corresponding to respective target mesh vertices based on brightness of pixels corresponding to the respective target mesh vertices,
wherein brightness of point primitives corresponding to the target mesh vertices is positively correlated with brightness of pixels corresponding to the target mesh vertices.

9. The method of claim 4, wherein the determining, based on the background image, sizes of point primitives corresponding to respective target mesh vertices comprises:
obtaining depths of pixels corresponding to respective target mesh vertices in the background image; and
determining sizes of point primitives corresponding to respective target mesh vertices based on depths of pixels corresponding to respective target mesh vertices,
wherein sizes of point primitives corresponding to the target mesh vertices are negatively correlated with depths of pixels corresponding to the target mesh vertices.

10. The method of claim 4, further comprising:
obtaining a moment corresponding to the rendering effect image; and
adjusting, based on the moment, brightness and/or sizes of point primitives corresponding to respective target mesh vertices.

11-14. (canceled)

15. An electronic device, comprising: a memory and a processor, wherein the memory is configured to store a computer program; the processor is configured to cause the electronic device to perform acts when executing the computer program, the acts comprising:
selecting a plurality of target mesh vertices from mesh vertices of a target virtual model based on a predetermined manner;
configuring point primitives corresponding to respective target mesh vertices;
rendering the target virtual model to obtain a background image;
determining attribute parameters of point primitives corresponding to respective target mesh vertices based on the background image; and
rendering point primitives corresponding to respective target mesh vertices on the background image based on the attribute parameters of point primitives corresponding to the respective target mesh vertices, to generate a rendering effect image for the target virtual model.

16. The electronic device of claim 15, wherein the selecting, based on a predetermined manner, a plurality of target mesh vertices from mesh vertices of a target virtual model comprises:
randomly selecting, based on a predefined number of point primitives, a same number of target mesh vertices from mesh vertices of the target virtual model.

17. The electronic device of claim 15, wherein the selecting, based on a predetermined manner, a plurality of target mesh vertices from mesh vertices of a target virtual model comprises:
dividing mesh vertices of the target virtual model into a plurality of mesh vertex sets based on a sparse degree of the predefined point primitives; and
randomly selecting a target mesh vertex from each mesh vertex set in the plurality of mesh vertex sets respectively.

18. The electronic device of claim 15, wherein the determining, based on the background image, attribute parameters of point primitives corresponding to respective target mesh vertices comprises at least one of:
determining, based on the background image, visibility parameters of point primitives corresponding to respective target mesh vertices, the visibility parameters comprising a first parameter for characterizing visibility of corresponding point primitives or a second parameter for characterizing invisibility of corresponding point primitives;
determining, based on the background image, rendering positions of point primitives corresponding to respective target mesh vertices;
determining, based on the background image, brightness of point primitives corresponding to respective target mesh vertices; or
determining, based on the background image, sizes of point primitives corresponding to respective target mesh vertices.

19. The electronic device of claim 18, wherein the determining, based on the background image, visibility parameters of point primitives corresponding to respective target mesh vertices comprises:
obtaining brightness of pixels corresponding to respective target mesh vertices in the background image;
deciding whether brightness of pixels corresponding to respective target mesh vertices is greater than or equal to a threshold brightness; and
determining, based on a result of the decision, visibility parameters of point primitives corresponding to the target mesh vertices.

20. The electronic device of claim 19, wherein the determining, based on decided results, visibility parameters of point primitives corresponding to the target mesh vertices comprises:
if brightness of pixels corresponding to the target mesh vertices is greater than or equal to the threshold brightness, determining visibility parameters of point primitives corresponding to the target mesh vertices as the first parameter; and
if brightness of pixels corresponding to the target mesh vertices is less than the threshold brightness, determining visibility parameters of point primitives corresponding to the target mesh vertices as the second parameter.

21. The electronic device of claim 18, wherein the determining, based on the background image, rendering positions of point primitives corresponding to respective target mesh vertices comprises:
obtaining position coordinates of respective target mesh vertices in the background image; and
determining position coordinates of respective target mesh vertices as rendering positions of point primitives corresponding to respective target mesh vertices.

22. The electronic device of claim 18, wherein the determining, based on the background image, brightness of point primitives corresponding to respective target mesh vertices comprises:
obtaining brightness of pixels corresponding to respective target mesh vertices in the background image; and
determining brightness of point primitives corresponding to respective target mesh vertices based on brightness of pixels corresponding to the respective target mesh vertices,
wherein brightness of point primitives corresponding to the target mesh vertices is positively correlated with brightness of pixels corresponding to the target mesh vertices.

23. The electronic device of claim 18, wherein the determining, based on the background image, sizes of point primitives corresponding to respective target mesh vertices comprises:
obtaining depths of pixels corresponding to respective target mesh vertices in the background image; and
determining sizes of point primitives corresponding to respective target mesh vertices based on depths of pixels corresponding to respective target mesh vertices,
wherein sizes of point primitives corresponding to the target mesh vertices are negatively correlated with depths of pixels corresponding to the target mesh vertices.

24. A computer readable storage medium, wherein a computer program is stored thereon, the computer program, when executed by a computing device, causes the computing device to perform acts, the acts comprising:
selecting a plurality of target mesh vertices from mesh vertices of a target virtual model based on a predetermined manner;
configuring point primitives corresponding to respective target mesh vertices;
rendering the target virtual model to obtain a background image;
determining attribute parameters of point primitives corresponding to respective target mesh vertices based on the background image; and
rendering point primitives corresponding to respective target mesh vertices on the background image based on the attribute parameters of point primitives corresponding to the respective target mesh vertices, to generate a rendering effect image for the target virtual model.
